(19) United States
(12) Patent Application Publication
(10) Pub. No.: US 2004/0094905 A1
(43) Pub. Date: May 20, 2004

(54) Thermally insulative, flexible, tubular oven gaskets with individual fasteners

(75) Inventor: Thomas L. Weil, Elverson, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Davlyn Manufacturing Co., Inc.

(21) Appl. No.: 10/300,719

(22) Filed: Nov. 20, 2002

(51) Int. Cl. F16J 15/02

(52) U.S. Cl. 277/628

(57) ABSTRACT

A composite oven gasket includes a flexible hollow tubular member braided from a number of glass fiber yarn ends and a lesser number of wire ends and a plurality of separate, individual clip fasteners extending though the tubular members and captured only by the yarn and wire ends defining the tubular body. At least forty-four yarn and wire ends are used in the tubular members and less than twenty percent of the ends are wire.

### BACKGROUND OF THE INVENTION

U.S. Pat. No. 5,107,623 discloses a gasket device with individual clip fastener for ovens and other uses. Each fastener includes a base and an engagement portion extending transversely from one side of the base. An elongated, knitted resilient metal wire core is provided with an outer jacket formed by nonmetallic, inorganic yarns of glass fiber braided around the core in a seamless fashion. The base of each fastener member is captured between the core and the outer jacket with the engagement portion of each fastener member extending through the yarns forming the jacket, substantially transversely to the core and outer jacket. U.S. Pat. No. 5,107,623 is incorporated by reference herein in its entirety.

U.S. Pat. No. 5,395,126 discloses a thermally insulative, tubular gasket formed by a composite braided tubular member and a single continuous wireform clip, which is bent to provide a plurality of connected fasteners. Each of the fasteners passes through the wall of the tubular member and is captured by the wall. The patent expressly discloses and claims a ratio of the yarn to wire ends in the braided tubular member of from about 1:1 to 3:1 and teaches making the tubular member of the gasket by providing one end of wire for each one to three consecutive ends of inorganic, nonmetallic yarn on separate spool carriers of a conventional circular braider. The resulting gasket is specifically disclosed as being suitable for high temperature use to insulate oven doors. U.S. Pat. No. No. 5,395,126 discloses that the advantage of this gasket over one having a core with a separate outer jacket is that one member, the core, is entirely omitted. The patent further states that the total amount of wire required for a gasket of given size and resilience is supposedly substantially reduced. However, the material savings typically amount to only a very few cents per gasket.

U.S. Pat. No. No. 5,806,149 discloses an improved, individual clip fastener, which was formed by bending a single piece of spring wire. The engagement portion of the clip fastener is pinched down in area where it projects from the clip base portion. The patent further discloses the use of such individual clips in a gasket with various tubular members including composite members formed of a first plurality of ends of non-metallic, inorganic yarns, such as yarns of glass fiber filaments braided with a second plurality of ends of resilient, flexible metal wires. The individual, spring wire clip fastener members are mounted to the composite tubular member with the engagement portion of each extending through adjoining portions of the yarns or yarns and wires. No specific disclosure of the construction of the composite tubular member is given.

U.S. Pat. No. No. 5,918,885 discloses another gasket or gasket like tubular device with separate individual bent wire attachment clips with are secured to the tubular body by passing free ends of the wire forming the clip into and out of the side wall forming the tubular member and folding the ends over upon themselves like the ends of a wire staple. This patent cites above U.S. Pat. No. 5,395,126 for a tubular member made of wire and glass fiber yarn braided on a circular braider and expressly discloses the same ratio of yarns to wires, from about seventy-five percent (75%) yarn to about twenty-five percent (25%) wire (1 to 3 ends ratio) up to about fifty percent (50%) yarn and fifty percent (50%) wire (1 to 1 ends ratio).

Although not disclosed in any of U.S. Pat. Nos. 5,395,126, 5,806,149 or 5,918,885, there is a significant change in the characteristics of the gasket itself by substituting wire for glass fiber yarn, particularly in the braided tubular members disclosed in those patents. The wire being substituted for the yarn is typically of a much smaller diameter than that of the yarn being replaced. While it is possible to utilize non-metallic, inorganic yarns of greater diameter than previously used in combination with wire strands, the resulting structures, even at a 3:1 ratio in favor of the yarn, are relatively more porous and more air permeable than are the all yarn outer jackets of the U.S. Pat. No. 5,107,623. Moreover, the larger yarns cost more, negating any cost saving in wire, and are heavier. It is believed that gaskets with composite tubular members having even the highest ratio of glass fiber yarn ends to metal wire ends disclosed in those patents (3:1), woven as disclosed in those patents, will be found by oven manufacturers to be undesirable if not unsuitable for use in place of conventional gaskets having all glass fiber yarn tubular members, on the basis of increased cost, increased weight, reduced performance or a combination of these factors.

### BRIEF SUMMARY OF THE INVENTION

An oven gasket comprising an elongated, thermally insulative, seamless, resiliently flexible, tubular member with a single wall surrounding a hollow interior and a plurality of fasteners spaced along the tubular member and projecting outwardly from the tubular member, the tubular member being formed by intertwining together in a regular pattern, a first plurality of ends of inorganic, nonmetallic, multi-filament yarns and a second plurality of ends of flexible, resilient individual metal wires, the ends of wire in the tubular member constituting less than one third of the ends of yarn in the tubular member and less than one quarter of the total number of wire and yarn ends constituting the tubular member, each fastener of the plurality including a base portion located within the hollow interior of the tubular member and an engagement portion passing through the wall and away from an outer surface of the tubular member, each fastener being individual and separated from each other fastener in the gasket, each engagement portion of each fastener expanding transversely outwardly while extending away from the base portion to define a pinched down traverse area in the engagement portion adjoining the base portion, each fastener being individually retained in the gasket by capture of the engagement portion in the pinched down transverse area by adjoining ones of the wires and yarns defining the wall of the tubular member around the pinched down area and each fastener being coupled with each other fastener and retained in the gasket only through mutual engagement of each fastener with the tubular member.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings which are all diagrammatic:

FIG. 1 depicts diagrammatically in prospective view, an improved gasket of the present invention installed in an oven;

FIG. 2 is a side elevation of a portion of the gasket in FIG. 1;

FIG. 3 is a fragmentary view of the attachment of the gasket to the oven in FIG. 1;

FIG. 4 is a local, enlarged, cross-section, taken along the lines 4-4 of FIG. 3;

### DETAILED DESCRIPTION OF THE INVENTION

Certain terminology is used in the following description for convenience only and is not intended to be limiting. The words “right”, “left”, “lower” and “upper” designate directions in the drawings to which reference is made. The words “radial” and “axial” refer to directions perpendicular to and along the central axis of cylindrical or tubular object, element or structure referred to while the words “inwardly” and “outwardly” refer to directions towards and away from, respectively, the geometric center of the object, element or structure. The terminology includes the words above specifically mentioned, derivatives thereof and words of similar import. Moreover, throughout the drawings, like numerals are used to indicate like elements.

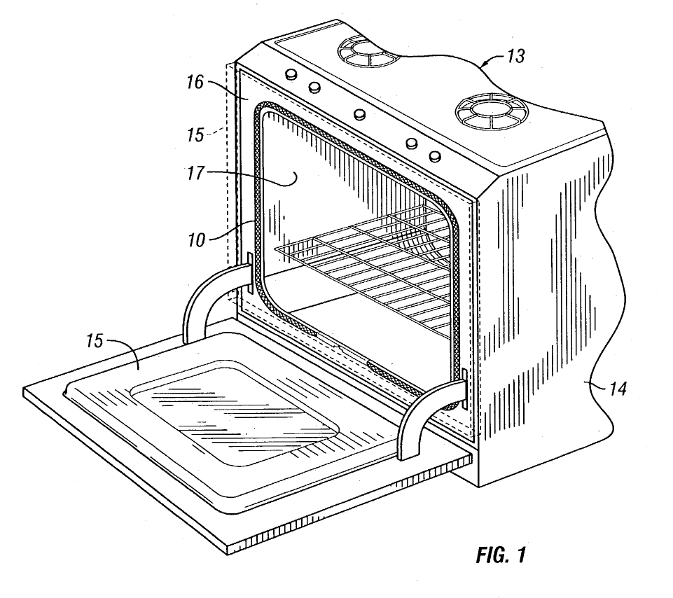

FIG. 1 depicts part of a preferred embodiment of the elongated, thermally insulative, flexible, tubular, gasket device of the present invention, which indicated generally of 10, installed in an oven 13. Oven 13 includes a first oven member 14 in the form of an oven body and a second oven member in the form of an oven door 15 covering an open end of the body 14. Door 15 is shown in solid in the open position and in phantom in the closed position. The gasket device 10 fills a space 16, which exists between the first and second oven members 14 and 15 when door 15 is closed.

The device 10, mounted between oven body 14 and door 15, is not subject to any significant vibration or abrasion. Rather, the major adverse environmental conditions to which the device 10 is exposed are heat and smoke from the oven, long-term compression and repeated flexure from opening and closing the oven door 15. The major functions of the gasket device 10 are to prevent the leakage of heat and smoke through the space 16 and to remain resilient and functional over the expected useful life of the oven.

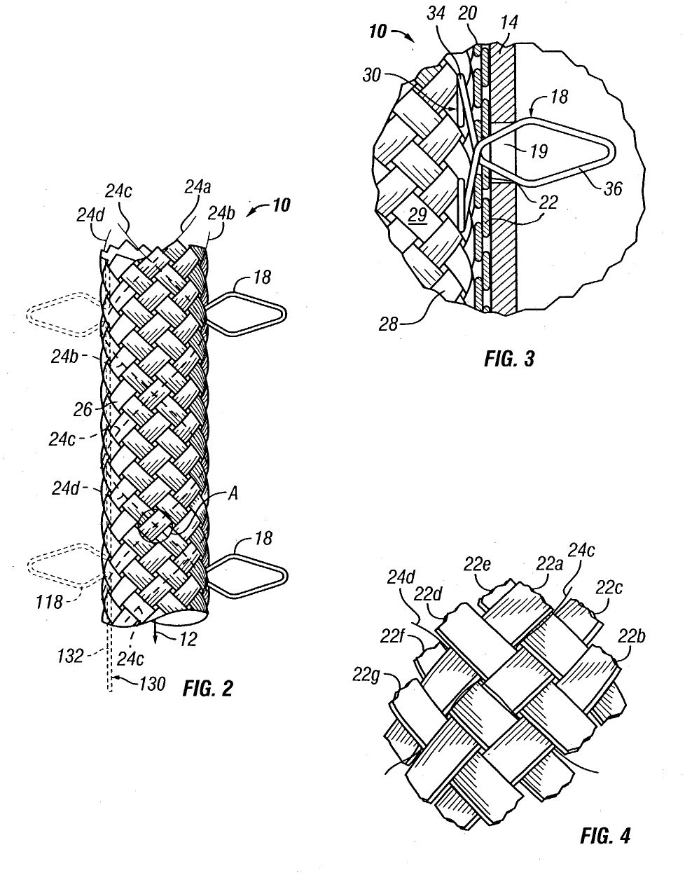

FIGS. 2 and 3 depict portions of the device 10 in greater detail. The portion of the device 10 depicted in FIG. 2 is continued in either of the two opposing longitudinal directions of the device 10, which are indicated by the opposing arrows 11 and 12, respectively. The device 10 is formed by an elongated, thermally insulative, seamless, resiliently flexible, tubular member 20. A plurality of fasteners 18 project generally radially from the tubular member 20 at predetermined, regular, spaced intervals along one side of the tubular member 20. As shown in FIG. 3, each fastener 18 is received preferably releasably in one of a like plurality of openings 19, which are provided also spaced apart from one another at the same predetermined, regular intervals, in a wall of the oven body 14 as depicted, or alternately, in openings in an inner wall of the oven door 15.

As can be seen best in FIG. 3, preferably each of the fasteners 18 is separate and individual and connected to each other fastener in the gasket 10 only through the tubular member 20. Each fastener 18 is preferably provided by a separate, individual, bent spring wire clip indicated at 30. Each clip 30 preferably is made from a single length of wire, which is bent to define a generally planar base portion or “base” 34 and an engagement portion or dart 36 projecting generally perpendicularly from one major side of the base 34. The details of forming and using the preferred bent wire spring clips 30 are disclosed in related U.S. Pat. No. No. 5,806,149, which is incorporated by reference herein. It will be appreciated, however, that other forms of separate, individual bent spring wire clips, as well as other forms of individual fasteners can be used to provide the plurality of separate individual fasteners 18 extending from the tubular member 20.

The tubular member 20 is hollow with a single wall 28 formed by a first plurality of yarn ends each indicated at 22a-22g in FIG. 4 and a second plurality of wire ends specifically indicated at 24a-24d in FIG. 2 and 24c, 24d in FIG. 4. Each of the yarn ends 22 is preferably formed by a continuous bundle of filaments of inorganic, non-metallic, heat resistant and insulative material, preferably glass fiber. Each of the wire ends 24a-24d is preferably provided by a single continuous strand of metal wire, preferably stainless steel. Each wire strand is of a thickness and hardness effective to permit the strand to be flexible enough to be worked in a conventional circular braider and to permit the tubular member 20 of the device to be partially compressed, yet resilient enough to restore the member 20 to at least nearly its original cylindrical shape even when transversely compressed for most of its useful life and repeatedly heated. It will be appreciated by those skilled in the art that other non-metallic, inorganic material may be substituted for the glass fiber yarn and other metals substituted for the stainless steel with increased cost, reduced performance or both for oven gasket use.

The first plurality of yarn ends 22 and second plurality of wire ends 24 are intertwined together in a regular pattern. Preferably the ends 22 and 24 are braided together using a conventional, multi-carrier circular braider (not depicted). The braider provides a single wall seamless tube 20 having a seamless wall 28 which surrounds a hollow interior 29 and which has a regular, repeated, herringbone-type pattern indicated generally by shading at 26 on the outer surface of the tubular member 20 in FIG. 2. In the first method of fabrication, each strand or wire ends 24a-24d is preferably individually wound on a spool that is mounted by itself on an individual carrier of the braider. The carriers carrying the wire spools are spaced as uniformly as possible among the remaining carriers of the braider so that the wires are uniformly distributed through the tubular member 20. The remaining braider carriers carry spools of only multifilament yarns. Oven gaskets like oven gasket 10 having a fully expanded seamless tubular member 20 are conventionally made on circular braiders mounting from forty-four to ninety-six spool carriers. The most common braiders have forty-eight, seventy-two and ninety-six carriers.

The four metal wire ends 24a-24d that have been provided in the tubular member 20 of this exemplary embodiment device 10 in FIG. 2 are extended from the upper end of the tubular member 20 in the figure to illustrate their locations. Each is also indicated to a degree in phantom in the remaining depicted portion of member 20 to illustrate their approximate positions and intersections with one another along the facing side of the tubular member 20 to define diamond shaped patterns running around and along the length of the tubular member 20.

As is also depicted in FIG. 3, the engagement portion 36 of each preferred clip 30 extends through the single wall 26 and between adjoining portions of the yarn ends 22 (or yarn and wire ends 22 and 24) and generally radially away from the tubular member 20. The engagement portion 36 of clip 30 pinches down in transverse area adjoining the base portion 34. It has been found that the wire and yarn ends 22 and 24 can be braided together sufficiently tightly so that the pinched down area of the engagement portion 36 of the clip 30 where the engagement portion 36 meets the base 34, is captured and reliably retained within the adjoining yarns or adjoining yarn and wire ends 22, 24. The base 34 remains within the hollow interior 29 of the tubular member 20 while the distal end of the engagement portion 36 projects away from the base 34 and the tubular member 20 while increasing in cross-sectional area. Again, an advantage of maintaining a relatively “tight” braid of the various ends 22, 24 is to more securely capture each individual clip 30.

It has been found that the tubular members of the oven gaskets disclosed in the aforesaid U.S. Pat. No. 5,395,126 can be improved upon in either of two ways: (1) by using fewer than twenty-five percent of the carriers of a circular braider to feed only wire ends and (2) feeding wire and yarn ends together from the same carrier or carriers of the circular braider. In this latter approach, the total number of ends in the tubular member exceed the total number of carriers on the circular braider used to braid the tubular member.

It should be appreciated initially that it is not necessary for the individual clips 30 (or other fastener used with these gaskets) to interact with the wire ends 24 in the tubular member 20. In other words. it is not necessary to surround the clips 30 with wires 24 to reliably capture and retain the individual clips 30 or other like fasteners 18 in a composite tubular member as is suggested by the above-identified prior art patents. Rather, it has been found that capture and reliable retention can be controlled by the density and tightness of the yarn and wire ends 22, 24 as a whole and, in view of the predominant number of glass fiber yarns 22 in the tubular members being disclosed, the density and tightness of just the braided glass fiber yarns. This is true even for separate, individual fasteners like spring clips 30. The purpose of the wire ends 24 is only to provide the resiliency needed by the device 10 to maintain its shape while being partially compressed and repeatedly heated between the oven members 14 and 15 over its operating life.

According to this first aspect of the present invention, it has been found that at least two but preferably only four to eight wire ends are needed to provide adequate resiliency in oven gasket tubular members made on forty-four to ninety-six carrier conventional circular braiders. Thus, tubular members 20 made on forty-four or forty-eight carrier braiders might contain only four to six wire ends. Four ends in a forty-four end tubular member 20 provides a 10 to 1 yarn to wire end ratio. Four and six ends in a forty-eight end tubular member provides an 11 to 1 and 7 to 1 yarn to wire end ratios, respectively. Six and eight wire ends in a tubular member made on a seventy-two carrier braider provide 11 to 1 and 8 to 1 yarn to wire ends ratios, respectively. The same numbers of wire ends in a member made on a ninety-six carrier braider provides 15 to 1 and 11 to 1 ratios. The ratios are much greater than the greatest ratio of yarn to wire ends (3 to 1) disclosed in the above identified prior art patents. In all embodiments of the present invention, the ratio of the numbers of yarn to wire ends is greater than 3 to 1 and preferably at least 5 to 1. In other words, the number of wire ends in a tubular member of the present invention is no more than twenty percent of the total number of yarn and wire ends braided together to form the tubular member and can be as low as four percent (four wires in ninety two ends).

For example, gasket 10 in FIG. 2 can be made on a forty-four carrier circular braider and includes four wire ends being fed from each eleventh carrier of the braider so that the ends 24a-24d are uniformly spaced apart from one another in the tubular member 20. Such a gasket might be made with four ends of seven mils., full hardened 304 stainless steel wire with forty ECG 37⅓ or ECG 37¼ sized glass fiber yarn ends or their equivalents. A member 20 having a nominal diameter of about one-half inch or more can be made on a seventy-two carrier braider with eight ends of six or seven mils., full hardened (about 300,000 psi tensile strength), 304 stainless steel wire and sixty-four ends of ECG 37¼ or ECG 37⅓ sized glass fiber yarns or their equivalents. It will be appreciated that full hardened 304 stainless steel wire from about four mils. up to about nine mils. in diameter could be used on such braiders and that the size of the glass fiber yarns can also be varied, for example from 37⅕ to 37½ or their equivalents. Also as few as four or as many as twelve wires might be used in this seventy-two end member providing between a range of 17 to 1 and 5 to 1 in yarn to wire end ratios.

According to the second aspect of this invention, wire and inorganic, non-metallic yarn ends may be fed together from a single spool carrier of a circular braider in a variety of ways. The wire and yarn may be simply wound together on a single spool, which is mounted on the carrier. It may be necessary to meter the wire strand and yarns as they are wound on a spool to assure the two will be fed together from the spool on the carrier. For example, it may be desirable to wind the yarn and the wire several turns around a drive head (capstan) and maintain the yarn at a tension approximating the tension that it will see when being fed from the braider to assure uniform feed lengths of both ends are wound on the spool. Alternatively, the wire ends and yarn can be twisted together and the twisted pair wound upon a spool. It is believed that only a few twists per foot would be necessary to keep the yarn and wire strands together on a spool for continuous feeding in a circular braider. A third option is to imbed the wire within the yarn. Yarns of this type may be obtained from a variety of commercial sources. For example, Auburn Manufacturing, Inc., of Mechanic Falls, Me., and/or Raybestos/Manhattan Engineering Products of Charlestown, S.C., will provide yarns with embedded wire to order. Lastly, it would be possible to provide a pair of modified spools (e.g. shorter than normal yarn spools), which could be mounted together on the same carrier with appropriate tensioners to meter the correct amounts of wire and yarn together from the carrier into the braid of the tubular member 20.

FIG. 4 is a greatly expanded schematic view of the tubular member 20 of FIG. 2 in the area A showing the interrelation of the wire strands and yarns in such members fabricated according to this first method. For example, wire strand 24c is fed with glass fiber yarn 22c from the same spool carrier and follows a similar path across and under transversely extending ends 22e, 22d, 24d, 22f and 22g. The paths of yarn end 22c and wire end 24c over and under ends 22d-22g and 24d are the opposite of the paths taken by the adjoining parallel running ends, which are yarns 22a and 22b. Similarly, wire end 24d follows the same path over and under transverse ends 22a-22c and 24c as is followed by adjoining yarn end 22d. When tubular members 20 are fabricated in this manner, yarns can be fed from all of the spool carriers of the braider resulting in a more uniform consistency to the weave and surface of the tubular member 20. Virtually any degree of sealing, which could be achieved by all glass fiber outer sleeves of the prior gaskets employing separate outer sleeves and inner tubular wire members, can be achieved in the new tubular members 20 of the present invention while eliminating a separate wire core. This further enables the look and feel of the tubular member to be adjusted if desired. For example, very few, relatively large and relatively thick wire strands can be provided in the tubular member resulting in a tubular member having a somewhat knotty appearance and feel as a result of the thick wires crossing over one another at discrete locations. On the other hand, relatively thin wires in greater numbers can be provided to increase the numbers of and reduce the spacing between crossovers so that a more uniformly smooth appearing and feeling tubular member can be provided.

It will be recognized by those skilled in the art that other changes could be made to the above-described embodiments and proposed embodiments of the invention without departing from the broad inventive concepts thereof. For example, the invention is intended to cover uses of the disclosed gaskets other than in or with ovens where their lack of porosity also would be advantageous. It should be understood, therefore, that the invention is not limited to the particular embodiments disclosed or suggested, but is intended to cover any modifications which are within the scope and spirit of the invention, as defined by the appended claims.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. An oven gasket comprising an elongated, thermally insulative, seamless, resiliently flexible, tubular member with a single wall surrounding a hollow interior and a plurality of fasteners spaced along the tubular member and projecting outwardly from the tubular member, the tubular member being formed by intertwining together in a regular pattern, a first plurality of ends of inorganic, nonmetallic, multi-filament yarns and a second plurality of ends of flexible, resilient individual metal wires, the ends of wire in the tubular member constituting less than one third of the ends of yarn in the tubular member and less than one quarter of the total number of wire and yarn ends constituting the tubular member, each fastener of the plurality including a base portion located within the hollow interior of the tubular member and an engagement portion passing through the wall and away from an outer surface of the tubular member, each fastener being individual and separated from each other fastener in the gasket, each engagement portion of each fastener expanding transversely outwardly while extending away from the base portion to define a pinched down traverse area in the engagement portion adjoining the base portion, each fastener being individually retained in the gasket by capture of the engagement portion in the pinched down transverse area by adjoining ones of the wires and yarns defining the wall of the tubular member around the pinched down area and each fastener being coupled with each other fastener and retained in the gasket only through mutual engagement of each fastener with the tubular member.

2. The gasket of claim 1 wherein the tubular member is formed from a total number of at least forty-four wire ends and yarn ends and the wire ends constitute less than twenty-five percent of the total number of wire and yarn ends.

3. The gasket of claim 1 wherein the total number of wire ends is between two and eight.

4. The gasket of claim 1 wherein the total number of wire ends is between two and four.

5. The gasket of claim 1 wherein a ratio of the ends of yarn to the ends of wire forming the tubular member is 6:1 or more.

6. The gasket of claim 5 wherein the ratio is 9:1 or more.

7. The gasket of claim 5 wherein the ratio is 12:1 or more.

8. The gasket of claim 5 wherein the ratio is between 12:1 and 48:1.

9. The gasket of claim 1 wherein the yarn ends and the wire ends are braided together to form the tubular member.

10. The gasket in claim 1 wherein the wire ends are each 15 mils or less in diameter and the yarn ends are fiberglass and each between 37½ and 37⅕ in size.

11. The gasket of claim 1 wherein each of the plurality of fasteners is an individual, bent, spring wire clip.

12. The oven gasket of claim 1 consisting essentially of the tubular member and the plurality of fasteners.

13. The gasket of claim 1 in combination with an oven having a body with an open end and a door covering the open end, the gasket being secured through the plurality of fasteners received in openings in one of the oven body and of the oven door.
